(19) United States
(12) Patent Application Publication
(10) Pub. No.: US 2024/0325236 A1
(43) Pub. Date: Oct. 3, 2024

(54) COMBINED MASSAGE DEVICE, NEGATIVE PRESSURE MASSAGE UNIT AND MASSAGE MACHINE

(71) Applicant: SHENZHEN VINCENT TECHNOLOGY CO., LTD, Shenzhen (CN)

(72) Inventor: Chengfeng WU, Shenzhen (CN)

(73) Assignee: SHENZHEN VINCENT TECHNOLOGY CO., LTD, Shenzhen (CN)

(21) Appl. No.: 18/200,024

(22) Filed: May 22, 2023

Related U.S. Application Data
(63) Continuation of application No. PCT/CN2023/084228, filed on Mar. 28, 2023.

(51) Int. Cl. A61H 7/00

(52) U.S. Cl. CPC A61H 7/008; A61H 2201/0107; A61H 2201/12

(57) ABSTRACT

A combined massage device, a negative pressure massage unit and a massage machine are provided. The combined massage device includes: a main body having a first connection portion and a reciprocating motion portion having a functional end, where the reciprocating motion portion is connected to the main body and has a degree of freedom of reciprocating motion relative to a direction of the main body, and the functional end is configured to have an independent massage function, and/or serves as a function supporting portion. The negative pressure massage unit and the massage machine that have the combined massage device are further provided.

### CROSS REFERENCE TO THE RELATED APPLICATIONS

This application is a continuation application of International Application No. PCT/CN2023/084228, filed on Mar. 28, 2023, the entire contents of which are incorporated herein by reference.

### TECHNICAL FIELD

The present disclosure relates to the technical field of massage machines, and in particular to a combined massage device, a negative pressure massage unit with a negative pressure sucking massage function, and a massage machine.

### BACKGROUND

A massage machine is used for massaging a human body, and a human body portion in contact with a massage portion is pressed, patted and rubbed or negative pressure sucking is formed by means of movement of the massage portion on the massage machine, thereby achieving an effect of soothing the body and mind of a user.

However, an existing massage machine, especially a portable miniaturized massage machine, is relatively single in massage form during use. A massage implementation solution with a sucking function is also relatively limited, a deformable closed cavity generally needs to be formed in advance, and negative pressure is generated by changing the shape of a cavity wall of the closed cavity. The modified negative pressure implementation solution defines that the functional core portion must be a negative pressure cavity, and an extension of a massage function thereof is limited. Moreover, for the manner by which the shape of the cavity is changed to achieve the negative pressure is likely to be affected by fatigue of a material, resulting in a function of a product being reduced after the product is used for a period of time, and generation of the negative pressure of the product is non-linear, which brings a large control problem for accurate program control massage.

In addition, different users have different massage strengths and massage frequency requirements, and the motion manner of basic massage cannot adapt to the massage requirements of different users, such that the use satisfaction of the massage machines on the market is poor.

### SUMMARY

In order to solve the above problems, the present disclosure employs the technical solutions as follows:

The present disclosure provides a reciprocating motion device. The device includes:
a combined massage device including:
a main body having a first connection portion, and
a reciprocating motion portion having a functional end,
where the reciprocating motion portion is connected to the main body and has a degree of freedom of reciprocating motion relative to a direction of the main body, and
the functional end is configured to have an independent massage function, and/or serve as a function supporting portion connected to an external combination to complete a combined function.

As one alternative embodiment, for the combined massage device,
the functional end is configured as a replaceable structure.

As one alternative embodiment, the combined massage device includes:
a first external combination having a piston cavity, where the functional end is configured to be a piston structure matching the piston cavity,
the first external combination is provided with a second connection portion,
the first connection portion is connected to the second connection portion, such that the piston structure of the reciprocating motion portion reciprocates in the piston cavity,
the first external combination is provided with a sucking port, and when a piston of the reciprocating motion portion reciprocates, formed air pressure changes to form a sucking massage effect at the sucking port.

As one alternative embodiment, the combined massage device includes:
a waterproof assembly,
where the waterproof assembly is arranged between the main body and the reciprocating motion portion, and is used for preventing water at a functional end side of the reciprocating motion portion from flowing to the other side.

As one alternative embodiment, for the combined massage device, when the first connection portion is connected to the second connection portion, the first external combination, the main body and the waterproof assembly form a second cavity in an enclosed manner, and
the second cavity has a ventilation channel in communication with the outside.

As one alternative embodiment, for the combined massage device, when the first connection portion is connected to the second connection portion, the first external combination, the main body and the waterproof assembly form a second cavity in an enclosed manner, and
at least one surface of the second cavity is a deformable surface and is configured to deform in response to an air pressure change in the second cavity.

As one alternative embodiment, the combined massage device includes:
a second external combination,
where the second external combination is provided with a third connection portion, the first connection portion is connected to the third connection portion, and
the second external combination is of a massage rod.

As one alternative embodiment, a negative pressure massage unit has:
the combined massage device.

As one alternative embodiment, a massage machine has:
the combined massage device.

As one alternative embodiment, the massage machine includes:
a transmission component having transmission connection end A and driving connection end B,
a driving component having a power assembly and driving connection end A, and
a stroke adjustment component,
where the transmission connection end A is connected to the reciprocating motion portion, and
the driving connection end A is connected to the driving connection end B.

The power assembly is used for providing power, and the power may be used for driving the transmission component and acts on the reciprocating motion portion, such that the reciprocating motion portion performs reciprocating periodic motion at a stroke L.

The stroke adjustment component is arranged in the transmission component and is used for adjusting a transmission ratio, such that a stroke ratio of the driving connection end B and the transmission connection end A in one period is changed; and/or
the stroke adjustment component is arranged at the joint between the driving connection end A and the driving connection end B, and is used for adjusting a transmission ratio, such that a stroke ratio of the driving connection end A and the transmission connection end A in one period is changed; and/or
the stroke adjustment component is arranged at the joint between the transmission connection end A and the reciprocating motion portion, and is used for adjusting a transmission ratio, such that a stroke ratio of the transmission connection end A and a functional connection end A is changed; and/or
the stroke adjustment component is arranged in the driving component and used for adjusting a stroke of the driving connection end A.

The present disclosure has the beneficial effects as follows:

The present disclosure provides the combined massage device, which is different from a massage machine product, and provides a standard massage solution with strong future function expansibility. The solution finds a common functional assembly, namely the reciprocating motion portion having the functional end, from a plurality of massage manners such as sucking, patting, rubbing and extruding. Unification of subsystems such as motion, transmission and control except the functional end is achieved, and the problems of poor iterative inheritance, huge waste, etc. in upgrading, updating and serialization processes of the product are solved. Specifically, small-cost fusion of various difficult-to-fuse large-difference functions such as sucking, patting and friction is achieved, and multi-functionalization of the product is achieved. From a production end, basic standardization of development of a series of products and terminal difference products is also achieved, distribution risk of multi-model and multi-functional product development is reduced, and competitiveness of product customization development is improved.

### BRIEF DESCRIPTION OF THE DRAWINGS

FIG. 1 is a schematic structural diagram of a massage device provided by the present disclosure;

FIG. 2 is a schematic structural diagram of another massage device provided by the present disclosure;

FIG. 3 is a schematic diagram for a process of connection between a massage unit and a massage device provided by the present disclosure;

FIG. 4 is a schematic diagram for states of a massage unit and a massage device provided by the present disclosure;

FIG. 5 is a schematic diagram for a process of connection between a first massage rod and a massage device provided by the present disclosure;

FIG. 6 is a schematic diagram for a state of connection between a first massage rod and a massage device provided by the present disclosure;

FIG. 7 is a schematic diagram for a process of connection between a massage ball and a massage device provided by the present disclosure;

FIG. 8 is a schematic diagram for a state of connection between a massage ball and a massage machine provided by the present disclosure;

FIG. 9 is a schematic diagram for connection between a flexible film and a housing provided by the present disclosure;

FIG. 10 is a sectional side view of FIG. 9;

FIG. 11 is an enlarged schematic diagram of portion A in FIG. 10;

FIG. 12 is a sectional structural diagram of a massage device provided by the present disclosure;

FIG. 13 is a schematic diagram for insertion connection between an insertion connection barrel and an insertion connection groove provided by the present disclosure;

FIG. 14 is an enlarged schematic diagram of portion B in FIG. 13;

FIG. 15 is a schematic structural diagram of an insertion connection barrel provided the present disclosure;

FIG. 16 is a schematic diagram of a section of an annular sucker provided by the present disclosure;

FIG. 17 is a schematic diagram for connection of a second massage rod provided by the present disclosure;

FIG. 18 is a schematic structural diagram of a second massage rod provided by the present disclosure;

### REFERENCE NUMERALS IN FIGURES

functional component 10, driving motor 11, transmission component 12, gear 13, rack 14
massage unit 20, first cavity 21, first end 22, first functional connection end B 23, airtight connection portion 24, and structural connection portion 25;
housing 30, opening 31, limiting member 32, limiting surface 321, insertion connection groove 33;
first massage rod 40, first clamping groove 41, end massage surface 42, circumferential massage surface 43;
massage ball 50, second clamping groove 51, and arc-shaped massage surface 52; and
flexible film 60, insertion connection barrel 61, second cavity 62, insertion connection end 63, annular sucker 64, contact end 65, ventilation groove 66, second massage rod 67, fixed sucker 68, and limiting ring 69.

### DETAILED DESCRIPTION OF THE EMBODIMENTS

The present disclosure will be further described below with reference to the accompanying drawings and the examples of the present disclosure.

### Example 1

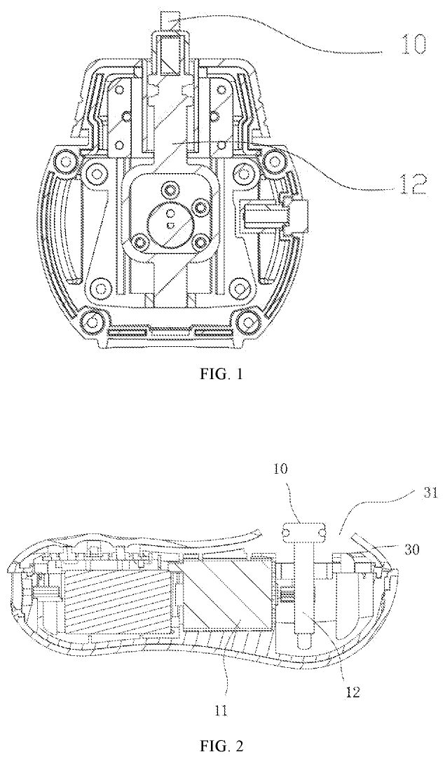

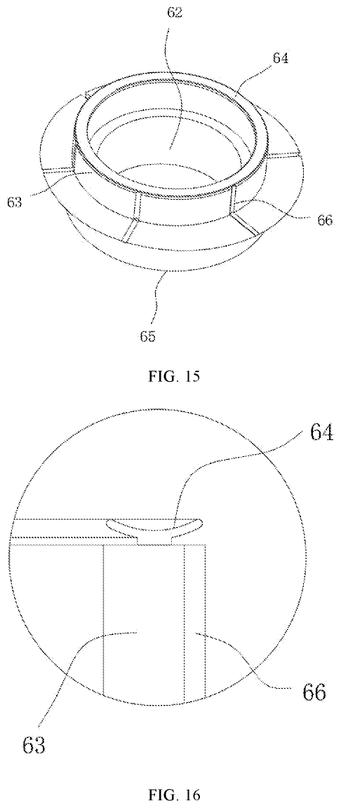

With reference to FIGS. 1-18, this example provides a combined massage device, and the device includes:
a main body having a first connection portion, and
a reciprocating motion portion having a functional end,
where the reciprocating motion portion is connected to the main body at the first connection portion and has a degree of freedom of reciprocating motion relative to a direction of the main body, that is, when the main body is fixed, the reciprocating motion portion may achieve a reciprocating motion action in a certain direction. It should be noted that implementation of the reciprocating motion of the reciprocating motion portion means that the reciprocating motion portion has the capability of such motion relative to the main body, rather than meaning that the reciprocating motion portion has a function phenomenon of automatic motion.

The functional end is configured to have an independent massage function, and/or serve as a function supporting portion connected to an external combination to complete a combined function.

The form of being “configured to have an independent massage function” may be as follows: the functional end is of a patting hammer, and when the reciprocating motion portion moves, a massage portion close to the patting hammer may be patted for massage.

When the functional end is configured to be a function supporting portion connected to an external combination to complete a combined function, the form may be as follows: the external combination may be configured as a massage rod, a piston, or other structures, and when the external combination is configured to a rubbing massage rod, the reciprocating motion may drive the massage rod to display a rubbing massage function. When the external combination is configured to be a piston, the functional end may serve as a plug body of the piston to move in a piston cylinder to change air pressure at an open end of the piston, thereby achieving a sucking massage function.

### Example 2

A combined massage device, where a functional end is configured as a replaceable structure. As a consumable, the functional end may be replaced to prolong a service life of the massage device, moreover, the functional end is replaceable, a low-cost function special design may be achieved, and a solution is provided for special function optimization.

### Example 3

A combined massage device includes:
a first external combination having a piston cavity,
where the functional end is configured to be a piston structure matching the piston cavity, and
the first external combination is provided with a second connection portion.

The first connection portion is connected to the second connection portion, such that the piston structure of the reciprocating motion portion reciprocates in the piston cavity, the first external combination is provided with a sucking port, and when a piston of the reciprocating motion portion reciprocates, formed air pressure changes to form a sucking massage effect at the sucking port.

In this example, a sucking function is achieved on the multi-functional massage main body moving in a reciprocating manner, and the cost is merely additionally arranging an external combination. Moreover, the external combination has a simple structure, the generated sucking effect has linear correlation with displacement of a motion portion, and the external combination is a sucking system that is extremely easy to achieve intelligent control by means of a program. Further, negative pressure sucking is achieved by means of the piston structure, and compared with a traditional manner of changing a volume of a flexible cavity to achieve sucking, the difference lies in that the negative pressure maintaining force provided by the piston structure is more rigid, and the negative pressure effect may not be changed due to nonlinear deformation or material fatigue of the cavity.

### Example 4

A combined massage device includes:
a waterproof assembly,
where the waterproof assembly is arranged between the main body and the reciprocating motion portion, and is used for preventing water at a functional end side of the reciprocating motion portion from flowing to the other side.

A waterproof solution is complex for a device having multiple movable portions, which requires comprehensive consideration of waterproofness, productivity, and composability. According to this example, the position between the main body and the reciprocating motion portion is set to have a waterproof function, such that the product combination becomes a massage device which has multiple functions and may satisfy the waterproof requirements of apparatus core functional components during use of washing and cleaning, and the cost problem and the manufacturing and assembling problems caused by a whole body waterproof design of the product are greatly reduced.

### Example 5

A combined massage device, where when the first connection portion is connected to the second connection portion, the first external combination, the main body and the waterproof assembly form a second cavity in an enclosed manner, and
the second cavity has a ventilation channel in communication with the outside.

When the device is designed as the solution of example 3, the waterproof function may form an airtight cavity. Under an action of the cavity, when the massage device is configured to have a sucking function, damping negative pressure which hinders generation of negative pressure of the function may be generated. The generation of the damping negative pressure may be released or slowed down by means of the solution of this example.

### Example 6

A combined massage device, where when the first connection portion is connected to the second connection portion, the first external combination, the main body and the waterproof assembly form a second cavity in an enclosed manner, and
at least one surface of the second cavity is a deformable surface and is configured to deform in response to an air pressure change in the second cavity.

This example is an alternative solution for example 4.

### Example 7

A combined massage device includes:
a second external combination,
where the second external combination is provided with a third connection portion, the first connection portion is connected to the third connection portion, and
the second external combination is of a massage rod.

### Example 8

A negative pressure massage unit has:
the combined massage device. This example designs a productization negative pressure massage unit by taking the combined massage device in the above examples as a core function, which is specially for achieving a sucking massage function.

### Example 9

A massage machine has:
the combined massage device. Further, the massage machine has:
a transmission component 12 having transmission connection end A and driving connection end B,
a driving component having a power assembly and driving connection end A, and
a stroke adjustment component,
where the transmission connection end A is connected to the reciprocating motion portion, and the driving connection end A is connected to the driving connection end B.

The power assembly is used for providing power, and the power may be used for driving the transmission component 12 and acts on a functional component 10, such that the functional component 10 may perform reciprocating periodic motion at a stroke L.

When an existing massage machine performs massage, a moving stroke of a massage portion is mostly fixed. However, different users may have different bearing degrees of massage strength, and such a massage manner formed in a fixing manner may only make some users be satisfied. For part of users, the situation that a pressing stroke/pressing force is too large possibly exists, and for another part of users, the situation that the pressing stroke/pressing force is too small may also exist. All users fail to be satisfied on one product, and use experience by the users is reduced due to a monotonous massage manner.

According to the reciprocating motion device provided by the example, the reciprocating motion device may be mounted in the massage device and provides reciprocating motion power for the massage portion of the massage device. Moreover, the provided reciprocating stroke is adjustable, and the users may adjust a moving stroke of the functional component 10 according to different use requirements.

The specific power assembly may be a driving motor 11 outputting rotational power, and the transmission component 12 may specifically employ gear+rack, crank+connecting rod, threaded transmission and other manners to convert rotational motion into a directional reciprocating movement.

A connection manner between the functional connection end A and the reciprocating motion portion and a connection manner between the transmission connection end A and the driving connection end B may be selected to be a rotational connection, a fixed connection, or other connection manner according to different transmission components 12 employed.

The stroke adjustment mechanism adjusts the transmission ratio by adjusting a rotation angle of the driving motor 11 or the position of a rotational connection point,
where the stroke adjustment component is arranged in the transmission component 12 and is used for adjusting a transmission ratio, such that a stroke ratio of the driving connection end B and the transmission connection end A in one period is changed.

For example, when the crank+connecting rod manner is employed for power conversion, the stroke adjustment component is arranged on a connecting rod and is used for adjusting a length of the connecting rod so as to achieve a stroke adjustment effect.

And/or
the stroke adjustment component is arranged at the joint between the driving connection end A and the driving connection end B, and is used for adjusting a transmission ratio, such that a stroke ratio of the driving connection end A and the transmission connection end A in one period is changed.

For example, when the crank+connecting rod manner is employed for power conversion, the stroke adjustment component is arranged at the joint between a connecting rod and a crank, and a stroke adjustment effect is achieved by controlling a distance between two hinged positions on the connecting rod.

And/or
the stroke adjustment component is arranged at the joint between the transmission connection end A and the reciprocating motion portion, and is used for adjusting a transmission ratio, such that a stroke ratio of the transmission connection end A and a functional connection end A is changed.

For example, when the crank+connecting rod manner is employed for power conversion, the stroke adjustment component is arranged at the rotation joint between a connecting rod and the functional component 10, and a stroke adjustment effect is achieved by controlling a distance between two hinged positions on the connecting rod or controlling a distance between a hinge point and the functional component 10.

And/or
the stroke adjustment component is arranged in the driving component and used for adjusting a stroke of the driving connection end A.

For example, when power conversion is performed by using the geartrack, the threaded transmission and other manners, the stroke adjustment component adjusts the position of the functional component 10 by controlling clockwise rotation and anti-clockwise rotation of the driving motor 11 so as to achieve a stroke adjustment effect.

### Example 10

This example is proposed on the basis of example 1, and further, a value range of the stroke L is 3-80 mm.

An existing massage device has a single function, which mainly lies in that a moving distance of a moving device for driving the massage portion to move is fixed and single, if different massage units are replaced, the moving distances of different massage units are the same, and difference embodied in a using process is small.

The value range of the stroke L is set to be 3-80 mm, and when the different massage units are replaced, motion ranges of motion portions of the massage units may be selected between 3-80 mm, such that the strokes when different massage machines may be driven may be adapted to improve the use manner of the massage device.

It should be noted that the massage units may be short spherical massage units in a stroke direction or long rod-shaped massage units in the stroke direction, and massage units which have cavities and have positive pressure airflows and negative pressure airflows when the functional component 10 moves periodically.

### Example 11

This example is proposed on the basis of example 9 or example 10, and further, the stroke adjustment component has:
a first stroke mode, and/or
a second stroke mode, and/or
a third stroke mode,
where when the first stroke mode acts, the value range of the stroke L is 3-10 mm,
when the second stroke mode acts, the value range of the stroke L is 3-15 mm, and
when the third stroke mode acts, the value range of the stroke L is 30-80 mm.

The strokes required by different massage units are also different, and when the functional component 10 moves periodically, since the massage unit performs massage by means of air pressure, the massage unit with positive pressure airflow and negative pressure airflow may adsorb a human body during the negative pressure airflow is generated. If the stroke is too large, suction force is increased and adsorption time is increased, in this case, skin at an adsorption position is likely to be damaged, and an aching feeling may be caused in the massage process. Therefore, the first stroke mode with a short stroke is preferably employed.

The short spherical massage unit in the stroke direction performs massage mainly by means of movement of a spherical front end, if the movement stroke is small, and a massage effect is not obvious, if the movement stroke is large, the massage ball 50 abuts against the skin, and then the main body portion of the massage device further has a reverse push stroke to destroy massage experience. Therefore, the second stroke mode with a relatively short stroke is preferably employed.

A main massage surface of the long rod-shaped massage unit in the stroke direction refers to rubbing between a circumferential surface of the rod-shaped massage unit and the human body, if the moving distance is short, a back and forth rubbing frequency is high, a massage direction is frequently changed, and massage comfort is poor. The movement stroke of the rod-shaped massage unit is increased, and an increase of the rubbing stroke of one-way massage is conductive to improving the comfort in the massage process. Therefore, the third stroke mode with a long stroke is preferably employed.

By presetting the stroke modes of different stroke ranges, and when the massage units are replaced, different stroke modes are selected according to the massage units, thereby assisting the users in quickly finding the optimal massage manner.

### Example 12

This example is proposed on the basis of example 11. Further,
a power control component is included,
where the power control component has a first power mode,
the power control component is connected to the driving component and is used for controlling the driving component, and
the first power mode is used for limiting an upper limit of output power of the functional connection end A to be P1.

The massage machine is a massage tool directly acting on the human body, a massage action is actively emitted by the massage machine, and driving power of the driving component directly determines massage strength of a massage portion. If the output massage force is relatively large, damage may be caused to the human body during massage. Especially, when an adsorption type massage manner is selected, there is a strong aching feeling after the skin is adsorbed, and damage to the skin is also large.

The upper limit of the output power of the functional connection end A is limited by means of the power control component, which also limits the magnitude of massage force at the massage portion, such that the massage force is kept in a safe range, and damage to the human body during massage is avoided.

### Example 13

This example is proposed on the basis of example 12, and further, the power control component has:
a second power mode,
where the second power mode is used for limiting an lower limit of the output power of the functional connection end A to be P2, or/and an upper limit to be P3.

For different massage units, the massage areas and the massage manners are different, and the required massage force is also different. The situation that the better the massage strength is, the better the massage effect is not true. Especially for the spherical massage unit and the rod-shaped massage unit, when such a physical patting or rubbing massage manner is selected, during use, the massage comfort is weakened due to too small massage force, and even the massage unit does not work after being subjected to resistance.

Therefore, the second power mode is set to limit the lower limit and the upper limit of the output power of the functional connection end A, such that the massage effect of the massage machine is kept within a comfortable and safe force range during massage.

### Example 14

This example is proposed on the basis of example 12 or 13. Further, P2>3*P1,
where the first power mode and the first stroke mode operate simultaneously, and/or,
the second power mode and the second stroke mode operate simultaneously.

The upper limit P1 of the first power mode is one third of the lower limit P2 of the second power mode, and when a massage manner of airflow patting and adsorption is employed, the human body is more sensitive to the adsorption massage of the airflow, and if the adsorption force is too large, damage to an adsorption portion of the human body may be caused. When a massage manner of physical patting and rubbing is employed, if patting flapping force and rubbing force are too small, the massage effect is weakened. Therefore, different power modes are preset for different massage units so as to achieve the optimal massage effect and safety of the corresponding massage unit. The first power mode and the first stroke mode operate simultaneously, and the second power mode and the second stroke mode operate simultaneously, such that quick matching between the massage unit and the corresponding power mode and stroke mode is achieved, and multiple selection processes of a client are reduced.

### Example 15

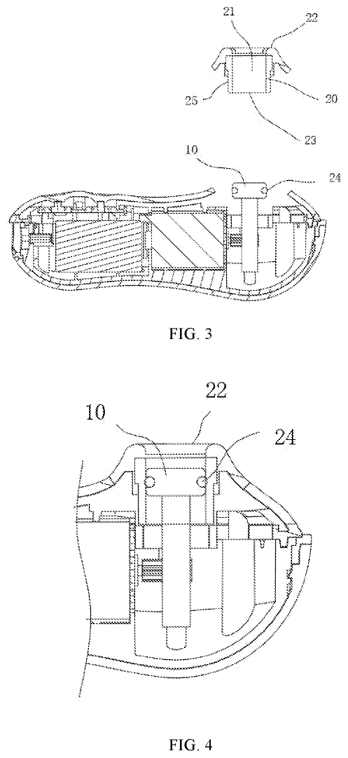

With reference to FIG. 3 and FIG. 4, this example provides a massage unit 20, and the massage unit includes a massage unit body,
where the massage unit body has a first cavity 21,
the first cavity 21 has an open first end 22, and,
a first functional connection end B 23.

The first end 22 is configured to act on a massage portion.

The first functional connection end B 23 may be coupled to the functional connection end A in examples 1-6 by means of a first coupling assembly, and the first coupling assembly has an airtight connection portion 24, or/and a structural connection portion 25.

The airtight connection portion 24 is configured to partially hermetically connect the massage unit 20 and the functional component 10, and when the functional component 10 reciprocates periodically, the open first end 22 has a positive pressure airflow and a negative pressure airflow relative to atmospheric pressure P0.

The massage effect achieved by the massage manner of single physical patting or rubbing is limited, especially when a portion which is sensitive of the human body is massaged, the manner of the physical patting manner which is suitable for other portions is too strong, and there is no comfortable feeling of massage.

According to the massage unit 20 provided by this example, the massage unit is detachably connected to the massage device or the reciprocating motion device in the massage device, the massage unit 20 is mounted on the massage device as an additional assembly when the sensitive portion of the human body needs to be massaged, and patting and adsorption of the airflow are used to replace physical patting of a physical massage unit 20 for massage.

During connection, the structural connection portion 25 is connected to the main body of the massage device, and the functional component 10 extends into the first cavity 21 of the massage unit body, and the airtight connection portion 24 may specifically be of a rubber sealing ring, which is arranged on the functional component 10 in a sleeving manner.

During massage, the functional component 10 moves in the first cavity 21 to change a size of the first cavity 21 close to the first end 22, such that air in the first cavity 21 is pushed out, or external air is sucked into the first cavity 21, thereby generating positive pressure and negative pressure airflows relative to the atmospheric pressure P0 for massage.

The massage unit 20 having the first cavity 21 may be detached when other portions with slightly lower sensitivities of the human body are massaged, and the massage units with physical patting or rubbing manners are selected for massage of the human body.

### Example 16

With reference to FIGS. 1-18, this example provides a massage device. The massage device includes the reciprocating motion device in any one of examples 1-6, or/and the massage unit 20 in example 15.

The reciprocating motion of the functional component 10 in the reciprocating motion device may directly act on the human body to massage the human body, and the stroke of massage is adjusted by means of the stroke adjustment component to change the massage stroke and force of the massage device, such that a user obtains the required massage manner.

In addition, the massage unit 20 provided in example 7 may also be added to the massage portion, and air is driven to flow by means of an airtight movement of the functional component 10 of the reciprocating device in the cavity of the massage unit 20 so as to generate a positive pressure airflow and a negative pressure airflow, such that airflow patting and adsorption massage is performed on the human body, and optionality of the massage effect of the massage device is improved.

### Example 17

With reference to FIG. 2, this example is proposed on the basis of example 16. Further, a housing 30, a position detection mechanism and a controller are included,
where the power assembly is of a driving motor 11, and driving connection end A is a rotation output end of the motor.

The driving motor 11 is arranged in the housing 30, and the housing 30 has an opening 31 in the stroke L direction.

The opening 31 enables the functional component 10 and the massage unit 20 to move at the opening 31, retract or extend out of the housing 30, and massage the human body after extending out of the housing 30 to provide an activity space for a movement of the functional component 10 and the massage unit 20, which is also conductive to a motion of the reciprocating motion device.

The housing 30 further includes a limiting member 32, the limiting member 32 has a limiting surface 321, and the limiting surface 321 is in contact with the transmission component 12 and/or the functional component 10 to limit a moving direction of the functional component 10.

The function of the limiting member 32 is to limit the functional component 10 and the massage unit 20 to move in a fixed stroke direction to limit same to deflect towards other directions, and when the transmission component 12 may output a linear motion, such as a linear motion of a rack, the position of the rack may be directly limited. When the transmission component 12 performs power conversion in the crank and connecting rod manner, both a crank and a connecting rod may deflect and do not remain a linear motion. The functional component 10 is directly limited, such that the functional component 10 may perform linear motion. If the functional component 10 is provided with the massage unit in a sleeving manner, the functional component 10 is limited by the massage unit, or the massage unit and the functional component 10 are relatively fixed to limit the position of the massage unit.

The position detection mechanism is arranged in the housing 30 and detects the position of the functional component 10 in the stroke L direction.

The position detection mechanism may be specifically a distance sensor or a Hall sensor.

When the position detection mechanism is the distance sensor, the distance sensor is arranged at an end portion of the functional component 10 in the moving direction, and by taking a portion in the functional component 10 as a reference point to detect a relative distance between the reference point and the distance sensor, thereby calculating the position where the functional component 10 is located.

When the position detection mechanism is the Hall sensor, a plurality of Hall sensors may be arranged in the moving direction of the functional component 10. The functional component 10 is provided with a marking point for shielding the Hall sensor, and when the marking point passes through a position of a certain Hall sensor, the Hall sensor sends a signal, which indicates that the functional component 10 is in the position.

The controller receives the position of the functional component 10 detected by the position detection mechanism, and controls rotation of the driving motor 11 and/or the stroke adjustment component.

The controller may specifically be a processor or a circuit board storing a control program, receives the position of the functional component 10 provided by the position detection mechanism, and controls the rotation of the driving motor 11 and/or the stroke adjustment component according to selection of the user.

The controller controls the stroke mode of the stroke adjustment component and/or the power mode of the power control mechanism.

### Example 18

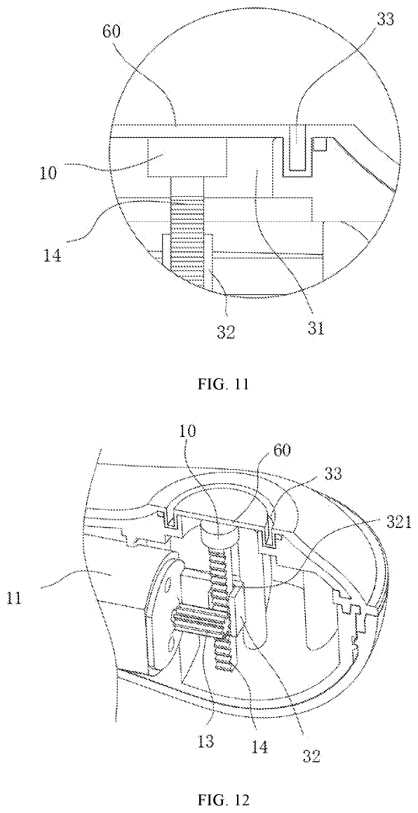

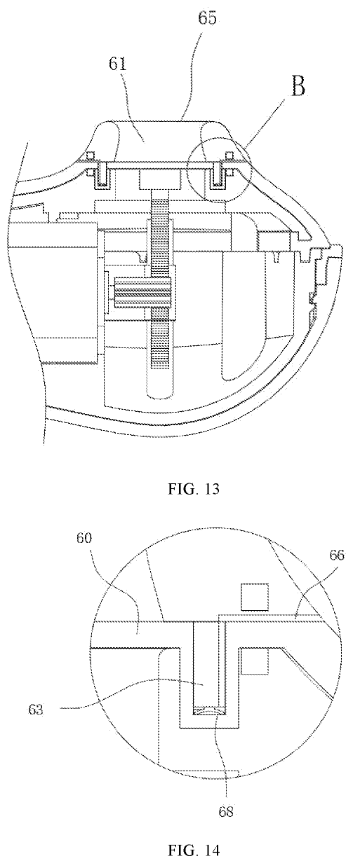

This example is proposed on the basis of example 17. With reference to FIG. 12 and FIG. 13, further, the transmission component 12 includes a gear 13 and a rack 14, the driving connection end B is located at the center of the gear 13, the transmission connection end A is located at one end of the rack 14, and the rack 14 and the gear 13 are meshed with each other.

The gear 13 and the rack 14 are meshed with each other, and rotation of the gear 13 drives the rack 14 to move together. Compared with other driving manners, a moving direction of the rack 14 is perpendicular to a rotating shaft of the driving motor 11. On both sides of the rotating shaft of the motor, a movement of the rack 14 may not be blocked by the motor, such that both ends of a length direction of the rack 14 have spaces to move, and an increase of a length of the rack 14 is supported. During driving of a movement of the functional component 10, the functional component 10 has a greater moving distance, such that an optional interval of the massage stroke/massage strength of massage for the user is increased.

When the transmission component 12 is of the gear 13 and the rack 14, at least three limiting surfaces 321 are included for limiting, the degree of freedom of opposite sides of a connection between the rack 14 and the gear 13 and left and right sides adjacent thereto is limited, and the gear 13 also limits the degree of freedom of the rack 14 of moving towards one side of the gear 13, such that the rack 14 may only be oriented under driving of the gear 13.

For the power conversion manner by using the gear 13 and the rack 14, the moving direction and speed of the rack 14 may be quickly changed in a clockwise rotation and anti-clockwise rotation switching manner of the motor, and the massage stroke and strength also change accordingly.

### Example 19

This example is proposed on the basis of example 17. With reference to FIG. 3 and FIG. 4, further, the structural connection portion 25 is detachably connected to the housing 30.

After the structural connection portion 25 is connected to the housing 30, the massage unit may be relatively fixed, and the functional component 10 reciprocates in the first cavity 21 of the massage unit.

### Example 20

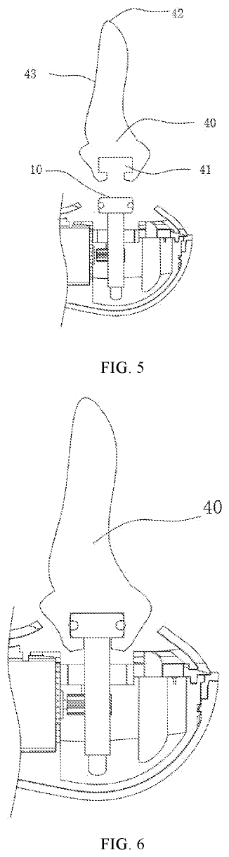

This example is proposed on the basis of example 17. With reference to FIG. 5 and FIG. 6, further, a first massage rod 40 is further included.

The first massage rod 40 is provided with a first clamping groove 41 connected to the functional component 10.

The first massage rod 40 is an elongated rod body, the first clamping groove 41 is arranged at one end of the first massage rod 40, and the first massage rod 40 has an end massage surface 42 opposite the other end of the first clamping groove 41 and/or a circumferential massage surface 43 in a circumferential direction of the first massage rod 40.

When the first massage rod 40 is used for massage, the first clamping groove 41 is pressed in the direction of the connection portion, such that the functional component 10 is clamped into the first clamping groove 41, and the functional component 10 drives the first massage rod 40 to move for massage. The first clamping groove 41 may be a groove having an opening, the shape is the same as that of the connection portion, and the first clamping groove is in interference fit with the connection portion, and the first clamping groove 41 and the connection portion are fixed in an inserted manner. The first clamping groove 41 may also be a groove with a smaller opening, and the connection portion of the first massage rod 40 is made of an elastic material. During insertion into the connection portion, the connection portion is vigorously pressed into the first clamping groove 41, such that the opening portion of the first clamping groove 41 is deformed. After the functional component 10 enters the first clamping groove 41, the functional component 10 is limited in the first clamping groove 41 at the opening, such that the functional component is prevented from falling off, as shown in FIG. 5.

The end massage surface 42 of the first massage rod 40 presses the human body for massage, driving force is directly applied to the human body, while the circumferential massage surface 43 is driven by the connection portion to move after the circumferential direction of the first massage rod 40 is in contact with the human body to generate rubbing with the human body, thereby performing massage.

### Example 21

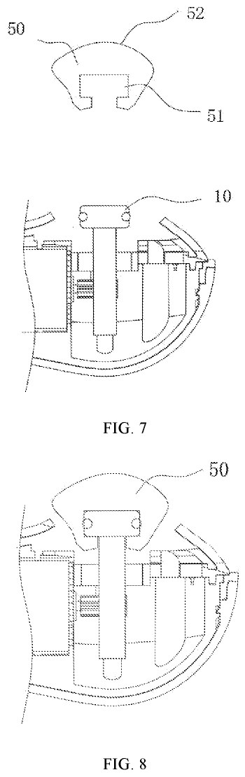

This example is proposed on the basis of example 17. With reference to FIG. 7 and FIG. 8, further, a massage ball 50 is further included.

The massage ball 50 is provided with a second clamping groove 51 connected to the functional component 10.

The massage ball 50 is provided with an arc-shaped massage surface 52, and the arc-shaped massage surface 52 and the second clamping groove 51 are oppositely arranged.

When the massage ball 50 is used for massage, the second clamping groove 51 is pressed in the direction of the functional component, such that the functional component is clamped into the second clamping groove 51, and the functional component drives the massage ball 50 to move for massage. The specific configuration of the second clamping groove 51 may refer to the first clamping groove 41.

The arc-shaped massage surface 52 of the massage ball 50 is located in the direction of the movement stroke of the functional component 10, and directly applies force during the movement on the human body to press and massage the human body.

### Example 22

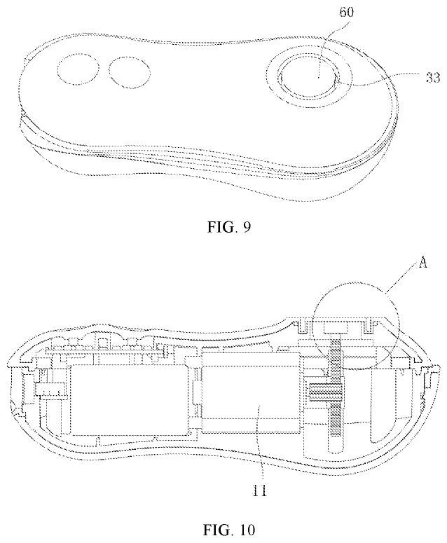

This example is proposed on the basis of example 17. With reference to FIGS. 9-13, further, the housing 30 is further provided with a flexible film 60, where the flexible film 60 is arranged outside the opening 31, and the flexible film 60 is fixedly connected to the housing 30.

The functional connection end A is connected to a middle of the portion, located at the opening 31, of the flexible film 60.

An interior of the housing 30 and an exterior of the housing 30 are partitioned by the flexible film 60, such that impurities such as dust entering the housing 30 and a body fluid generated by the human body during massage are avoided, a failure rate of the massage device is reduced, use sanitation of the massage device is ensured, and the massage device is convenient to clean.

A middle of the flexible film 60 is driven by the connection portion to move away from or close to the motor, and the portion, between the middle and the opening 31 of the housing 30, of the flexible film 60 is pulled and deformed. During use, the flexible film 60 is directly attached to the portion needing to be massaged, and the human body is pressed and massaged by means of the movement of the middle of the flexible film 60.

When the functional component 10 is pulled into the housing 30, the middle of the flexible film 60 is also pulled into the housing 30, and in this case, the portion, between the middle and the opening 31 of the housing 30, of flexible film 60 is pulled and deformed. Moving of the position of the flexible film 60 may occur on a surface of the flexible film 60, in this case, the flexible film 60 is in contact with the human body, and rubbing may occur between the moving flexible film 60 and the human body, that is, in one motion period of the functional component 10, the human body may be pressed and rubbed for massage so as to implement multiple massage manner together.

### Example 23

This example is proposed on the basis of example 22. With reference to FIGS. 13-15, further, an insertion connection barrel 61 is further included, and the insertion connection barrel 61 has a through second cavity 62.

Two ends of the second cavity 62 are an insertion connection end 63 and a contact end 65 respectively, and the contact end 65 is in contact with the human body.

A periphery of the opening of the housing 30 is provided with an insertion connection groove 33, and the flexible film 60 is laid along a groove bottom and a groove wall of the insertion connection groove 33.

The insertion connection end 63 and the insertion connection groove 33 may be inserted and fitted, and the insertion connection end 63 is in interference fit with the insertion connection groove 33.

For the insertion connection barrel 61 with both ends through, after the insertion connection end 63 is inserted into the insertion connection groove 33 of the housing 30, the second cavity 62 becomes a cavity opened by the contact end 65, and a volume of the cavity changes with the movement of the connection portion. When the connection portion moves towards the end close to the insertion connection barrel 61, the flexible film 60 follows same to deform towards the end close to the insertion connection barrel 61, such that air in the cavity is discharged, and the discharged airflow impacts the skin of the human body. When the functional component 10 moves towards the end away from the insertion connection barrel 61, the flexible film 60 follows same to deform towards the end away from the insertion connection barrel 61, such that the volume in the cavity becomes larger, and the contact end 65 is in contact with the human body to generate negative pressure to suck and massage the human body.

For the insertion connection fit manner of the insertion connection groove 33 and the insertion connection end 63, the insertion connection barrel 61 may be inserted into the insertion connection groove 33 when the insertion connection barrel 61 needs to be used for massage. When only the flexible film 60 is used for deformation for massage, the insertion connection barrel 61 is not mounted, and the flexible film 60 is directly used for massage.

The flexible film 60 is laid along the groove bottom and the groove wall of the insertion connection groove 33 to be wrapped around the housing 30, such that impurities and the body fluid are prevented from entering the massage machine, and the insertion connection groove 33 may be flushed and cleaned conveniently after use.

### Example 24

This example is proposed on the basis of example 23. With reference to FIGS. 14-16, further, an annular sucker 64 is arranged on the side, close to a bottom of the insertion connection groove 33, of the insertion connection end 63, a ventilation groove 66 is provided in a peripheral direction of the insertion connection barrel 61, and the ventilation groove 66 enables a non-suction surface of the annular sucker 64 outside the insertion connection barrel 61 to be in air communication with the exterior of the housing 30.

A thickness of the housing 30 is limited, and the excessively thick housing 30 may increase the overall weight of the massage machine, and also causes material waste. The insertion connection groove 33 is provided in the housing 30, and if a depth of the insertion connection groove 33 connected to the insertion connection end 63 of the insertion connection barrel 61 is too small, the situations of unstable connection and falling off during use are likely to occur. Moreover, if the connection between the insertion connection barrel 61 and the insertion connection groove 33 is unstable, the joint is also likely to leak during use, which causes the airflow impacting the human body to be reduced during massage and the negative pressure to become weak during sucking, and therefore, the massage effect becomes poor.

The annular sucker 64 is arranged at the insertion connection end 63 and is arranged in a circular manner along the circumference of the insertion connection barrel 61, when the insertion connection end 63 is inserted into the insertion connection groove 33, the insertion connection barrel 61 is pressed, and the annular sucker 64 is adsorbed on the groove bottom of the insertion connection groove 33 after being pressed, and fixed to the groove bottom of the insertion connection groove 33. By setting the manner of the annular sucker 64 and the insertion connection groove 33, multiple degrees of freedom of the insertion connection barrel 61 on the housing 30 may be restricted to avoid dropping of the insertion connection barrel 61 during use.

Due to the interference fit between the insertion connection end 63 and the insertion connection groove 33, after the insertion connection end 63 is inserted into the insertion connection groove 33, the air pressure in the insertion connection groove 33 is increased, and if the insertion connection barrel 61 is pressed therebetween to achieve fitting between the annular sucker 64 and the groove bottom of the insertion connection groove 33, air between an adsorption surface of the sucker and the groove bottom of the insertion connection groove 33 is difficult to completely discharge, which causes unstable adsorption of the annular sucker 64.

The ventilation groove 66 is provided in the periphery of the insertion connection barrel 61, such that after the insertion connection end 63 is inserted into the insertion connection groove 33, the air in the peripheral direction of the insertion connection barrel 61 circulates by means of the ventilation groove 66, thereby ensuring that the air pressure of the non-adsorption surface of the annular sucker 64 on one side of the periphery of the insertion connection barrel 61 is the same as that of the exterior of the insertion connection groove 33. During mounting, the annular sucker 64 is pressed, and air between the adsorption surface of the annular sucker 64 and the groove bottom of the insertion connection groove 33 is discharged from the peripheral direction of the insertion connection barrel 61, such that the annular sucker 64 may be tightly adsorbed on the groove bottom of the insertion connection groove 33. After the annular sucker 64 is tightly adsorbed, air flowing passages on both sides of the annular sucker 64 are blocked, thereby avoiding leakage of the air from the insertion connection groove 33 in the massage process.

### Example 25

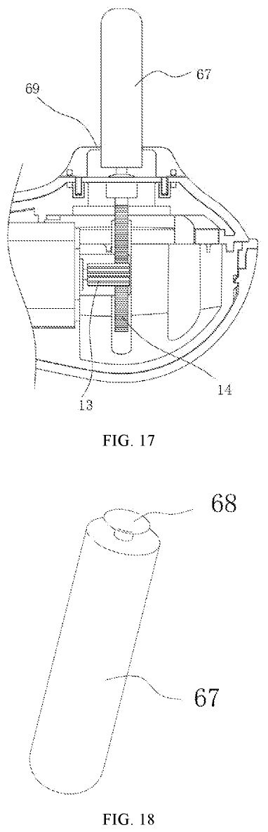

This example is proposed on the basis of example 23. With reference to FIG. 17 and FIG. 18, further, the second cavity 62 is provided with a second massage rod 67, one end of the second massage rod 67 is provided with a fixed sucker 68, and the fixed sucker 68 may be connected to the flexible film 60 in an adsorbed manner.

The contact end 65 of the insertion connection barrel 61 is provided with a limiting ring 69, and an inner side of the limiting ring 69 is in sliding fit with the second massage rod 67.

The second massage rod 67 is an elongated rod body, and the second massage rod 67 has an end massage surface 42 arranged at the other end opposite the fixed sucker 68 and/or a circumferential massage surface 43 arranged a circumferential direction of the second massage rod 67.

The second massage rod 67 and the flexible film 60 are detachably connected by means of the fixed sucker 68, and when the second massage rod 67 needs to be used for massage, firstly, the insertion connection end 63 of the insertion connection barrel 61 is connected to the insertion connection groove 33, and then the fixed sucker 68 of the second massage rod 67 is fixedly connected to the flexible film 60.

The second massage rod 67 is in sliding fit with the inner side of the limiting ring 69, such that the degree of freedom of the second massage rod 67 in a non-massage direction is limited, and the second massage rod 67 is prevented from deflecting during massage.

In the description of the examples of the present disclosure, it needs to be understood that the orientation or positional relationships indicated by the terms “up”, “down”, “front”, “rear”, “left”, “right”, “vertical”, “horizontal”, “center”, “top”, “bottom”, “top portion”, “bottom portion”, “inside”, “outside”, “inner side”, “outer side”, etc. are based on the orientation or positional relationship shown in the accompanying drawings, are merely for facilitating the description of the present disclosure and simplifying the description, rather than indicating or implying a device or element referred to must have a particular orientation or be constructed and operated in a particular orientation, and therefore will not be interpreted as limiting the present disclosure. The term “inner side” refers to an interior or an area or space enclosed, and the term “periphery” refers to an area around a specific component or a specific area.

In the description of the examples of the present disclosure, the terms “first”, “second”, “third” and “fourth” are for descriptive purposes only and are not to be construed as indicating or implying their relative importance or implicitly specifying the number of indicated technical features. Thus, a feature defined with “first”, “second”, “third” and “fourth” may explicitly or implicitly include one or more of the features. In the description of the present disclosure, “plurality of” means two or more, unless otherwise specified.

In the description of the examples of the present disclosure, it should be noted that, unless otherwise explicitly specified and defined, the terms “mounting”, “connecting”, “connection” and “assembling” should be understood in a broad sense, for example, they may be a fixed connection, a detachable connection, or an integrated connection; and may be a direct connection, or an indirect connection via an intermediate medium, or communication inside two elements. For those of ordinary skill in the art, the specific meanings of the above terms in the present disclosure may be understood according to specific circumstances.

In the description of the examples of the present disclosure, the specific features, structures, materials or characteristics described may be combined in any one or more examples or instances in a suitable manner.

In the description of the examples of the present disclosure, it should be understood that “-” and “˜” represent the range of two values, and the range includes endpoints. For example, “A-B” represents a range greater than or equal to A and less than or equal to B. “A˜B” represents a range greater than or equal to A and less than or equal to B.

In the description of the examples of the present disclosure, the term “and/or”, which is merely an association relation describing an associated object, means that there may be three relations, for example, A and/or B may represent three situations: A exists alone, A and B exist at the same time, and B exists alone. In addition, the character “/” in the description generally indicates that successive association objects are in an “or” relation.

Although the examples of the present disclosure have been illustrated and described, it should be understood that those of ordinary skill in the art may make various changes, modifications, replacements and variations to the above examples without departing from the principle and spirit of the present disclosure, and the scope of the present disclosure is limited by the appended claims and their legal equivalents.

1. A combined massage device, comprising:
a main body having a first connection portion, and
a reciprocating motion portion having a functional end,
wherein the reciprocating motion portion is connected to the main body and has a degree of freedom of reciprocating motion relative to a direction of the main body, and
the functional end is configured to have an independent massage function, and/or serve as a function supporting portion connected to an external combination to complete a combined function.

2. The combined massage device according to claim 1, wherein
the functional end is configured as a replaceable structure.

3. The combined massage device according to claim 1, comprising:
a first external combination having a piston cavity,
wherein the functional end is configured to be a piston structure matching the piston cavity,
the first external combination is provided with a second connection portion,
the first connection portion is connected to the second connection portion, wherein the piston structure of the reciprocating motion portion reciprocates in the piston cavity,
the first external combination is provided with a sucking port, and when a piston of the reciprocating motion portion reciprocates, formed air pressure changes to form a sucking massage effect at the sucking port.

4. The combined massage device according to claim 3, comprising:
a waterproof assembly,
wherein the waterproof assembly is arranged between the main body and the reciprocating motion portion, and is configured for preventing water at a functional end side of the reciprocating motion portion from flowing to the other side.

5. The combined massage device according to claim 4, wherein when the first connection portion is connected to the second connection portion, the first external combination, the main body and the waterproof assembly form a second cavity in an enclosed manner, and
the second cavity has a ventilation channel in communication with outside.

6. The combined massage device according to claim 4, wherein when the first connection portion is connected to the second connection portion, the first external combination, the main body and the waterproof assembly form a second cavity in an enclosed manner, and
at least one surface of the second cavity is a deformable surface and is configured to deform in response to an air pressure change in the second cavity.

7. The combined massage device according to claim 1, comprising:
a second external combination,
wherein the second external combination is provided with a third connection portion, the first connection portion is connected to the third connection portion, and
the second external combination is of a massage rod.

8. A negative pressure massage unit, having:
the combined massage device according to claim 1.

9. A massage machine, having:
the combined massage device according to claim 1.

10. The massage machine according to claim 9, comprising:
a transmission component having a transmission connection end A and a driving connection end B,
a driving component having a power assembly and a driving connection end A, and
a stroke adjustment component,
wherein the transmission connection end A is connected to the reciprocating motion portion, and
the driving connection end A is connected to the driving connection end B;
the power assembly is configured for providing a power, and the power is configured for driving the transmission component and acts on the reciprocating motion portion, wherein the reciprocating motion portion performs a reciprocating periodic motion at a stroke L;
the stroke adjustment component is arranged in the transmission component and is configured for adjusting a first transmission ratio, wherein a stroke ratio of the driving connection end B and the transmission connection end A in one period is changed; and/or
the stroke adjustment component is arranged at a joint between the driving connection end A and the driving connection end B, and is configured for adjusting a second transmission ratio, wherein a stroke ratio of the driving connection end A and the transmission connection end A in one period is changed; and/or
the stroke adjustment component is arranged at a joint between the transmission connection end A and the reciprocating motion portion, and is configured for adjusting a third transmission ratio, wherein a stroke ratio of the transmission connection end A and a functional connection end A is changed; and/or
the stroke adjustment component is arranged in the driving component and configured for adjusting a stroke of the driving connection end A.

11. The combined massage device according to claim 2, comprising:
a first external combination having a piston cavity,
wherein the functional end is configured to be a piston structure matching the piston cavity,
the first external combination is provided with a second connection portion,
the first connection portion is connected to the second connection portion, wherein the piston structure of the reciprocating motion portion reciprocates in the piston cavity,
the first external combination is provided with a sucking port, and when a piston of the reciprocating motion portion reciprocates, formed air pressure changes to form a sucking massage effect at the sucking port.

12. The combined massage device according to claim 2, comprising:
a second external combination,
wherein the second external combination is provided with a third connection portion, the first connection portion is connected to the third connection portion, and
the second external combination is of a massage rod.

13. The negative pressure massage unit according to claim 8, wherein in the combined massage device, the functional end is configured as a replaceable structure.

14. The negative pressure massage unit according to claim 8, wherein the combined massage device comprises
a first external combination having a piston cavity,
wherein the functional end is configured to be a piston structure matching the piston cavity,
the first external combination is provided with a second connection portion,
the first connection portion is connected to the second connection portion, wherein the piston structure of the reciprocating motion portion reciprocates in the piston cavity,
the first external combination is provided with a sucking port, and when a piston of the reciprocating motion portion reciprocates, formed air pressure changes to form a sucking massage effect at the sucking port.

15. The negative pressure massage unit according to claim 14, wherein the combined massage device comprises
a waterproof assembly,
wherein the waterproof assembly is arranged between the main body and the reciprocating motion portion, and is configured for preventing water at a functional end side of the reciprocating motion portion from flowing to the other side.

16. The negative pressure massage unit according to claim 15, wherein in the combined massage device, when the first connection portion is connected to the second connection portion, the first external combination, the main body and the waterproof assembly form a second cavity in an enclosed manner, and
the second cavity has a ventilation channel in communication with outside.

17. The negative pressure massage unit according to claim 15, wherein in the combined massage device, when the first connection portion is connected to the second connection portion, the first external combination, the main body and the waterproof assembly form a second cavity in an enclosed manner, and
at least one surface of the second cavity is a deformable surface and is configured to deform in response to an air pressure change in the second cavity.

18. The massage machine according to claim 9, wherein in the combined massage device, the functional end is configured as a replaceable structure.

19. The massage machine according to claim 9, wherein the combined massage device comprises
a first external combination having a piston cavity,
wherein the functional end is configured to be a piston structure matching the piston cavity,
the first external combination is provided with a second connection portion,
the first connection portion is connected to the second connection portion, wherein the piston structure of the reciprocating motion portion reciprocates in the piston cavity,
the first external combination is provided with a sucking port, and when a piston of the reciprocating motion portion reciprocates, formed air pressure changes to form a sucking massage effect at the sucking port.

20. The massage machine according to claim 19, wherein the combined massage device comprises
a waterproof assembly,
wherein the waterproof assembly is arranged between the main body and the reciprocating motion portion, and is configured for preventing water at a functional end side of the reciprocating motion portion from flowing to the other side.
